(19) United States
(12) Patent Application Publication
(10) Pub. No.: US 2004/0060161 A1
(43) Pub. Date: Apr. 1, 2004

(54) Methods of forming a heart valve stent

(76) Inventors: David Leal, Austin, TX (US); Chris Heinrich, Austin, TX (US); James Hamblin, Lockhart, TX (US); Riyad Moe, Austin, TX (US)

Correspondence Address: Timothy L. Scott, Senior Intellectual Property Counsel, SULZER MEDICA USA INC., 3 East Greenway Plaza, Suite 1600, Houston, TX, 77046, US

(21) Appl. No.: 10/256,761

(22) Filed: Sep. 27, 2002

(51) Int. Cl. B23P 13/04; B23K 1/20; B23K 17/00

(52) U.S. Cl. 29/558; 29/557

(57) ABSTRACT

The present invention is directed to various methods of forming a heart valve stent. In one embodiment, the method comprises providing a cylinder of material, the cylinder having an outside diameter and an inside diameter, the inside diameter having a first dimension, forming a plurality of stent posts on an end of the cylinder, and increasing the inside diameter of the cylinder of material to a second dimension, the second dimension being greater than the first dimension.

### BACKGROUND OF THE INVENTION

1. Field of the Invention

The present invention is generally directed to heart valve stents, and, more particularly, to methods of making heart valve stents.

2. Description of the Related Art

Prosthetic heart valves may be used to replace diseased natural heart valves in human patients. Mechanical heart valves typically have a rigid orifice ring and rigid hinged leaflets coated with a blood compatible substance such as pyrolytic carbon. Other configurations, such as ball-and-cage assemblies, have also been used for mechanical valves.

In contrast to mechanical heart valves, bioprosthetic heart valves comprise valve leaflets formed of a flexible biological material. Bioprosthetic valves or valve components obtained from a human donor are referred to herein as a “homografts,” while non-human animal valves or valve components are termed “xenografts.” A third class of valves includes polymer valves, which comprise at least some elastomeric polymer component, including specifically polymeric valve leaflets. Although many bioprosthetic valves have no added support structures, both bioprosthetic and polymer valves may include a structural support member, or stent, to support the leaflets and maintain the anatomical structure of the valve.

Stented polymeric valves may be prepared by providing a stent member by various manufacturing processes such as cutting a stent from a tube member or other known machining processes, and coupling the stent to the polymer components by, e.g. encapsulation of the stent in a mold. Stented bioprosthetic valves generally are prepared in one of two ways. In one technique, a complete valve is obtained from a human, porcine, or other mammalian donor, chemically treated to improve biocompatibility (which may include cross-linking the tissue), and coupled to a stent. The stent provides structural support to the valve and, with a sewing cuff, facilitates attachment of the valve to the patient by suturing.

In another technique, individual valve leaflets are removed from a donor valve or are fashioned from other sources of biological material, e.g., bovine pericardium. The individual leaflets are then assembled by suturing the valve leaflets both to each other and to the stent. When bovine pericardium is used, the valve (trileaflet or bileaflet) is fashioned from one piece of pericardium. The material is then draped on the stent to form the “cusps.”

One of the major functions of stents is to serve as a framework for supporting and stabilizing the valve and for suturing it into place in the human patient. Toward that end, stents are frequently covered in whole or in part with a fabric, and have a cloth sewing or suture cuff (typically an annular sewing ring) attached to them. The annular sewing ring serves as an anchor for the sutures coupling the valve to the patient. Various stent designs have been implemented in a continuing effort to make valve implantation simpler and faster.

The durability of heart valve stents is an important determinant of the durability and performance of the valve as a whole. Stent durability depends on a number of factors, such as stent shape, material thicknesses, material properties, and residual stresses resulting from manufacturing operations used to form the stent. The shape of a heart valve stent is often complex, because it must be sufficiently flexible in some areas while providing necessary stiffness in other areas. Moreover, the stent must fit within a small volume defined by the leaflets of the valve.

Stents may be formed of a variety of materials, e.g., a metal or polymer, and they may be made by a variety of techniques. For example, stents may be formed from wire or by cutting the stent pattern from a flat piece of metal. However, both of these methods may result in undesirable levels of residual stress in the completed stent. Additional operations, such as annealing, may be performed in an attempt to reduce such stresses, but such processing may result in unacceptable warping of the stent. Moreover, wire-formed stents or stents formed from a flat piece of material must ultimately be joined, e.g., welded, in one or more locations to complete the stent. This joining operation creates one or more discontinuities that may experience excessively high stresses during the lifetime of the valve and stent, resulting in poor valve performance and/or failure. specifically, the presence of such discontinuities may reduce the fatigue life of the stent, and may make predictions of stent durability more difficult and less reliable.

In general, conventional (contact) machining or molding may be manufacturing processes that are more suitable for manufacturing the complex shapes of heart valve stents. However, conventional (contact) machining does result in some amount of residual stress in the stent that can reduce fatigue life and cause warping. In general, conventional machining tends to work better on thicker parts where warpage is less of a concern. For stents that require relatively thin sections (for flexibility), conventional machining of the stent may be difficult due to the residual stresses resulting from the machining process or the deflection of the stent as it is being machined.

Other non-contact methods of making a heart valve stent, such as laser machining and electric discharge machining (EDM), may be employed. While these non-contact manufacturing methods can be used to cut the complex shape of the stent with relatively low levels of residual stress, they can also leave a heat affected zone on the surface of the material that was exposed to, e.g., EDM processing. The heat affected zone may be more brittle then the base material, thereby tending to reduce the fatigue life of the stent, or making the prediction of fatigue life more difficult.

Molding can also be used to form heart valve stents, and has the advantage of allowing the formation of very complex shapes having varying thicknesses. However, molded parts tend to shrink and may become warped due to the presence of residual stresses. Moreover, it is difficult to predetermine the exact shape a molded part will take, and it is difficult to repeatedly make molded parts to that precise shape. Molding also takes more upfront capital and can accommodate fewer changes during product development.

The present invention is directed to various methods that may solve, or at least reduce, some or all of the aforementioned problems.

### SUMMARY OF THE INVENTION

The present invention is directed to various methods of forming a heart valve stent. In contrast to prior art approaches to stent fabrication, the present inventors have realized that residual manufacturing stresses in the stent, which can be significant sources of valve failure, can be significantly reduced by performing most of the forming operations on a workpiece having a relatively thick wall. Consequently, the present invention is directed to methods of stent formation in which reductions in wall thickness are performed relatively later among a series of fabrication processes. In particular, the present invention involves formation of stent posts on a workpiece having a relatively thick wall, and thereafter reducing the wall thickness of the stent by milling, lapping, grinding, boring, and/or like operations to increase an inner diameter of the stent and/or reduce the outer diameter of the stent.

In one illustrative embodiment, the method comprises providing a cylinder of material, the cylinder having an outside diameter and an inside diameter, the inside diameter having a first dimension, forming a plurality of stent posts on an end of the cylinder, and increasing the inside diameter of the cylinder of material to a second dimension, the second dimension being greater than the first dimension. In one aspect, the step of providing a cylinder of material may comprise providing a cylinder of solid material and performing an initial operation on the material to create the inside diameter of the first dimension.

In another illustrative embodiment, the method comprises providing a cylinder of material having an outside diameter and an inside diameter having a first dimension, performing a first operation to increase the inside diameter of the cylinder to an intermediate dimension greater than the first dimension, forming a plurality of stent posts on an end of the cylinder, and performing a second operation to increase the inside diameter of the cylinder from the intermediate dimension to a second dimension greater than the first dimension.

In yet another illustrative embodiment, the method comprises providing a cylinder of material having an outside diameter and an inside diameter having a first dimension, forming a plurality of stent posts on an end of the cylinder, performing a first operation to increase the inside diameter of the cylinder to an intermediate dimension greater than the first dimension, and performing a second operation to increase the inside diameter of the cylinder from the intermediate dimension to a second dimension greater than the intermediate dimension.

### BRIEF DESCRIPTION OF THE DRAWINGS

The invention may be understood by reference to the following description taken in conjunction with the accompanying drawings, in which like reference numerals identify like elements, and in which:

FIGS. 1-9 depict various views of a heart valve stent manufactured using one illustrative embodiment of the methods disclosed herein for manufacturing a heart valve stent.

While the invention is susceptible of various modifications and alternative forms, specific embodiments thereof have been shown by way of example in the drawings and are herein described in detail. However, the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

The present invention will now be described with reference to the Figures. The relative sizes of the various features and structures depicted in the drawings may be exaggerated or reduced as compared to the size of those features or structures on real-world devices. Nevertheless, the attached drawings are included to describe and explain illustrative examples of the present invention. For clarity, not all features of an actual implementation of the invention in a particular heart valve are described in detail. For example, numerous heart valve geometries can be used in conjunction with the present invention, but are not presented here because those aspects of heart valve fabrication are known in the art.

In general, the present invention is directed to various methods of making heart valve stents. As will be recognized by those skilled in the art after a complete reading of the present application, the present invention may be employed in forming heart valve stents useful with a variety of different heart valves to be implanted into a patient, e.g., xenografts, homografts, etc. Moreover, the particular details described herein are provided by way of example. Thus, the present invention should not be considered as limited to such details unless such details are specifically set forth in the appended claims.

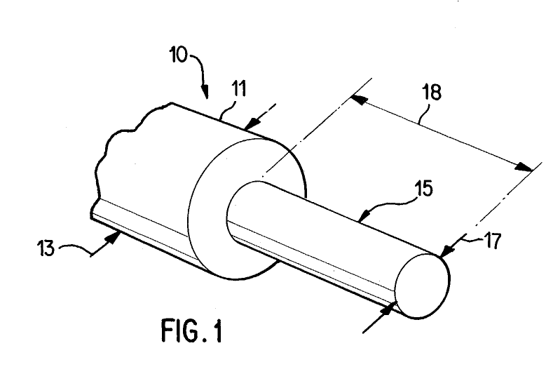

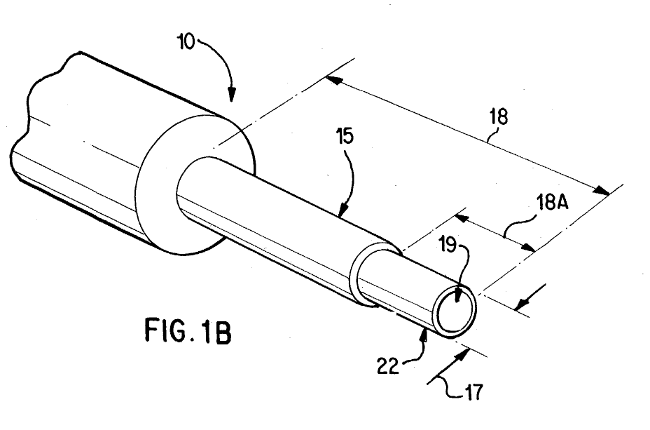

As shown in FIG. 1, a length of bar stock material 10 having an outer surface 11 may be provided. The outside diameter 13 of the bar stock material 10 may vary depending upon the desired finished size of the completed heart valve stent. For example, the bar stock material 10 may have an outside diameter 13 of approximately 0.75-1.5 inches. The bar stock material 10 may be comprised of a variety of materials, such as a metal, e.g., titanium, stainless steels, or nickel-titanium alloys, by way of nonlimiting example. If desired, an annealing process may be performed on the bar stock material 10. As will be understood by those skilled in the art after a complete reading of the present application, the methods disclosed herein may also be employed when using an extruded tube of material as the initial starting material for the stent. As with the bar stock material 10, such a tube of material may be comprised of a variety of different materials and its wall thickness may vary. Thus, the present inventive methods should not be considered as limited to use with a particular type of starting material unless such limitations are clearly set forth in the appended claims.

In the case where the heart valve stent is formed from bar stock material 10, the initial step involves performing a turning operation on the outer surface 11 of the bar stock material 10 to form a section 15 of the bar stock material 10 that has the desired finished outside diameter 17 of the heart valve stent. The absolute size of the final desired outside diameter 17 may vary depending upon the particular application. For example, in preferred embodiments, the final desired outside diameter may range from approximately 0.740-1.490 inches. The axial length 18 of the section 15 will be somewhat greater than the desired finished axial length of the heart valve stent for reasons to be described later. As an alternative, a machining operation may be performed to form the outside diameter of the section 15 to a dimension that is slightly greater than the final desired outside diameter 17. At some point later in the manufacturing process, another machining operation may be performed to reduce the outside diameter of the section 15 to the final desired outside diameter 17.

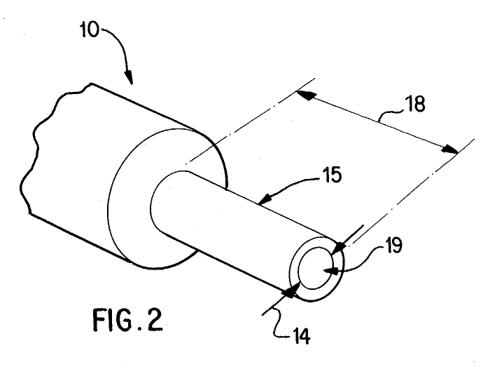

Next, as shown in FIG. 2, an operation is performed to form an opening 19 having an inside diameter 14 that is formed to a first dimension. This results in a cylinder of material, e.g., section 15, having an inside diameter 14 and an outside diameter 17. In general, the inside diameter 14 of the heart valve stent may be approximately 0.08-0.13 less than the outside diameter 17. The opening 19 may be formed by a variety of techniques, e.g., drilling, boring, electrical discharge machining, etc.

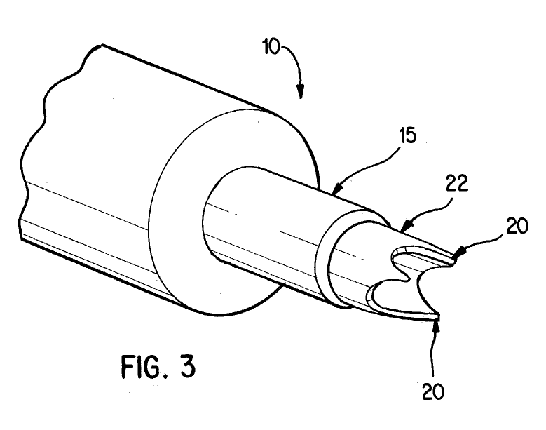

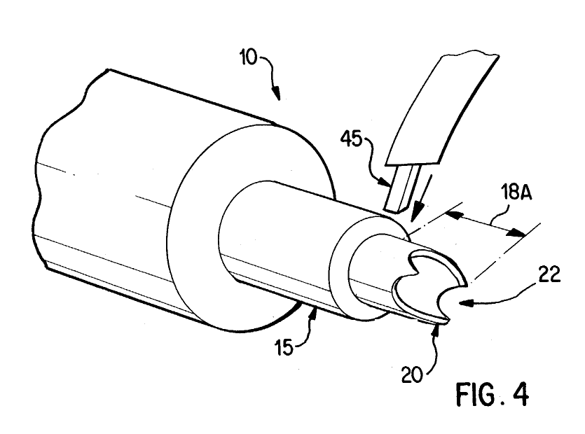

In one embodiment, as shown in FIG. 3, the next operation involves forming a plurality of heart valve stent posts 20 on one end of the section 15. The posts 20 may be formed by a variety of techniques, e.g., by performing a milling operation to remove portions of the wall of section 15, thereby creating the stent posts 20. The size and shape of the posts 20 may be varied as a matter of design choice. In a preferred embodiment, as shown in FIG. 4, the section 15 is then cut to the desired final axial length 18A to thereby result in the heart valve stent 22. This cutting operation may be performed on a standard lathe (not shown) using an illustrative tool 45 depicted in FIG. 4. The axial length 18A of the stent 22 may vary. In some embodiments, the axial length 18A of the stent 22 may range from approximately 0.75-1.0 inches.

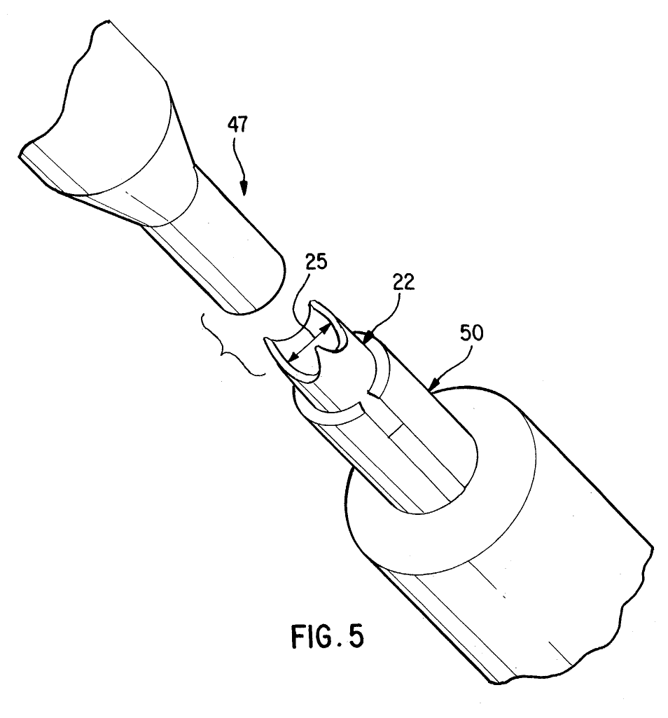

After the stent 22 is cut from the section 15, an operation is preferably performed to increase the inside diameter 14 of the stent 22 to an intermediate dimension 25 as shown in FIG. 5. In a particularly preferred embodiment, the intermediate dimension 25 may be such that a wall thickness of approximately 0.010-0.030 inches results. That is, the inside diameter 14 of the stent 22 may be increased to within approximately 0.0005-0.005 inches of the desired finished inside diameter 55 of the stent 22. In one particular embodiment, this may be accomplished by performing an electrical discharge machining (EDM) process using an illustrative EDM electrode 47. Alternatively, a boring or lapping process may be used to increase the inside diameter of the stent 22 to the intermediate dimension 25. In one embodiment, the stent 22 is held by known collet or chuck type mechanisms 50, as schematically depicted in FIG. 5, during this process. Although described herein as being performed after the section 15 is cut to the desired axial length 18A, it will be appreciated that the step of increasing the inside diameter 14 to the intermediate dimension 25 may be performed before cutting the section to the desired axial length.

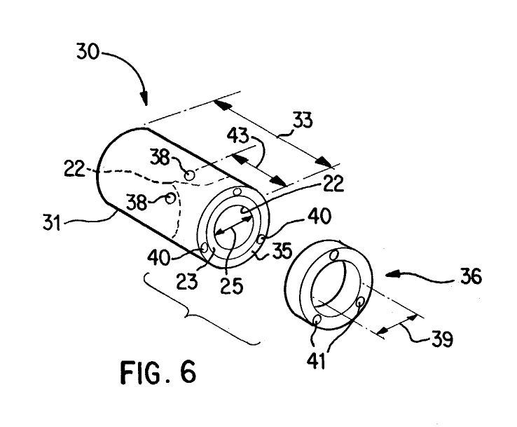

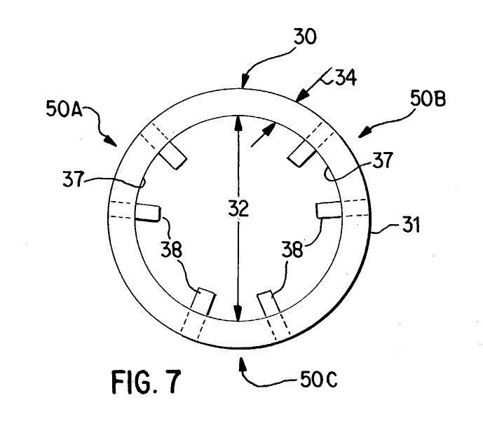

Thereafter, in one embodiment, the heart valve stent 22 is positioned in a fixture 30 for further forming operations. Fixture 30 preferably maintains the stent 22 stationary. FIGS. 6 and 7 depict a perspective view and an end view of one illustrative embodiment of the fixture 30 that may be used in forming the heart valve stent 22 of the present invention. As shown therein, the fixture 30 is comprised of a tube 31 having an inside diameter 32, a wall thickness 34, a cap 36, a plurality of holding pins 38, and a plurality of threaded holes 40.

The tube 31 may be comprised of a variety of materials, e.g., a tool steel (D2, A2), a stainless steel, etc., and it may be comprised of commercially available tubing or it may be machined from bar stock. The axial length 33 of the tube 31 may vary, e.g., 5-6 inches. The inside diameter 32 of the tube 31 should be sized so as to allow a slip fit with respect to the finished outside diameter 17 of the heart valve stent 22. For example, the inside diameter 32 of the tube 31 may be sized such that it is approximately 0.001 inches greater than the finished outside diameter 17 of the stent 22. Given this slip fit relationship, the fixture 30 may only be used with certain sized stents 22. That is, multiple fixtures 30 may be needed to accommodate all of the various sizes of heart valve stents 22. The wall thickness 34 of the tube 31 may also vary. In general, the wall thickness 34 may vary from approximately 0.5-0.75 inches. The wall thickness 34 of the tube 31 may vary, but it must be sufficient to provide for the threaded openings 40 formed in the tube 31. In the depicted embodiment (FIG. 6), three of the openings 40 are depicted although more or fewer may be used.

As shown in FIGS. 6 and 7, three sets 50A, 50B and 50C of two holding pins 38 are angularly spaced around the tube 31 approximately 120 degrees apart. In one illustrative embodiment, the holding pins 38 are approximately 0.25 inches in diameter, they are spaced apart by a distance that may depend upon part geometry, e.g., approximately 0.25 inches apart (center-to-center), and they extend inward by a distance that is approximately 0.001 inches less than the final wall thickness of the stent. The exact details of the layout and spacing of the holding pins 38 will need to be determined for each valve stent due to the variety of different possible configurations of the stent posts 20. The holding pins 38 may be comprised of a variety of materials, such as a tool steel (A2, D2), a stainless steel, etc. The holding pins 38 may be coupled to the tube 31 by a press fit or threaded connection.

In general, the stent 22 will be positioned in the tube 31 and secured therein by coupling the cap 36 to the tube 31. A portion of the stent 22 is depicted with hidden lines in FIG. 6. In one illustrative embodiment, this is accomplished by positioning a threaded fastener (not shown), e.g., 2-56 screws, through each of the axial openings 41 formed in the cap 36 and into threaded engagement with the threaded axial openings 40 in the tube 31. The pins 38 are positioned at an axial location 43 such that, when the stent 22 is fully inserted into the tube 31, the end 23 of the stent 22 extends approximately 0.002-0.005 inches beyond the end 35 of the tube 31. Thus, when the cap 36 is secured to the tube 31, it will be used to push the stent posts 20 against the holding pins 38, thereby securely capturing the stent 22. The holding pins 38 will be used to prevent rotation of the stent 22 during subsequent operations. The cap 36 has an inside diameter 39 that is slightly larger, e.g., approximately 0.002-0.025 inches, than the finished inside diameter 55 of the stent 22 for purposes that will be explained later.

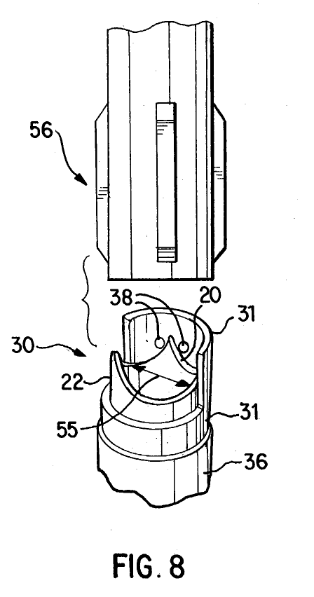

After the stent 22 is secured in the fixture 30, it will be secured in a collet or chuck type mechanism (not shown), and another operation will be performed to increase the inside diameter of the stent 22 from the intermediate dimension 25 to a second dimension 55, i.e., the final desired inside diameter of the stent 22, as indicated in FIG. 8. The operation used to form the final inside diameter should be a process that will provide very good thickness control due to the relatively thin wall of the stent 22. In one illustrative embodiment, a honing operation is performed to form the final inside diameter of the stent 22 using an illustratively depicted honing tool 56. During this process, the holding pins 38 of the fixture 30 prevent the stent 22 from rotating. Alternatively, a grinding or lapping process may also be performed to form the final inside diameter of the stent 22. Moreover, during the process of forming the desired final inside diameter, sufficient material, e.g., approximately 0.0005-0.005 inches, may be removed to reduce or eliminate the effects of forming the inside diameter to the intermediate dimension 25 by, for example, an electrical discharge machining process. That is, the operation used to form the final inside diameter of the heart valve stent 22 will preferably be such that the adverse effects of a prior EDM process, e.g., heart affected zones, may be reduced or eliminated.

In the embodiment depicted in the attached drawings, the inside diameter of the stent 22 is increased from a first dimension 14, to an intermediate dimension 25, and to a second, and final, dimension 55. However, not all embodiments of the present invention require such multi-step methodology. For example, in certain embodiments, the methods disclosed herein may involve only increasing the inside diameter of the stent 22 from a first dimension to a second dimension, wherein the second dimension is larger than the first dimension. Thus, the present invention should not be considered as limited to the particular manufacturing operations and steps disclosed herein unless such limitations are expressly set forth in the appended claims.

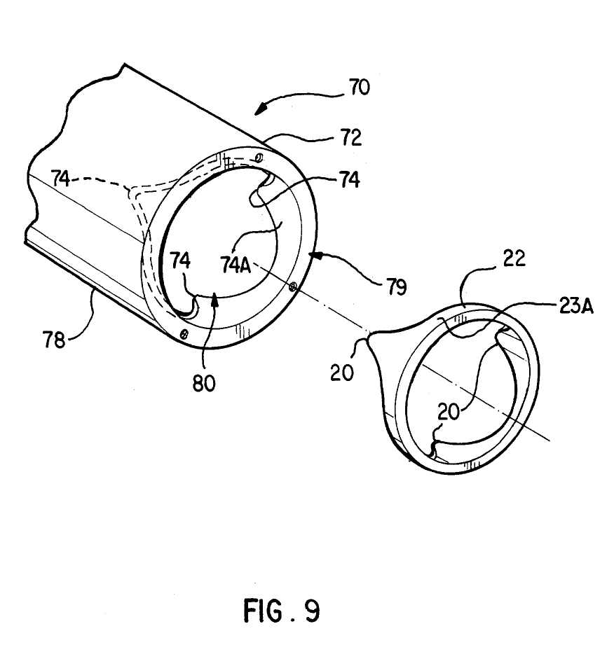

FIG. 9 depicts an alternative fixture 70 that may be employed with the present invention. As shown therein, the fixture 70 is comprised of a tube 72 having an inner diameter at a first, distal region 79 that is slightly less than the desired final inside diameter 55 of the heart valve stent 22. A plurality of shaped recesses 74 are formed in the wall 78 of the tube 72 in a second, proximal region 80. The internal recesses 74 are formed such that the stent posts 20 on the stent 22 nest in the shaped recesses 74 during subsequent forming operations. A slip fit may be provided between the exterior surface 23A of the stent 22 and the interior surface 74A of the tube 72 in the second region 80 defined by the shaped recesses 74. The stent 22 may be secured to the tube 72 through use of a cap 36 (not shown in FIG. 9) similar to that depicted in FIG. 6. The cap 36 may be secured to the tube 72 by a plurality of threaded connections similar to that depicted in FIG. 6. After the stent 22 is secured in the fixture 70, it may be secured in a collet or chuck mechanism (not shown) and various operations, e.g., honing, boring, lapping, EDM machining, etc., may be performed on the interior surface of the stent 22.

In one illustrative embodiment, the present invention is directed to a method of forming a heart valve stent that comprises providing a cylinder of material, the cylinder having an outside diameter and an inside diameter, the inside diameter having a first dimension, forming a plurality of stent posts on an end of the cylinder, and increasing the inside diameter of the cylinder of material to a second dimension, the second dimension being greater than the first dimension. The cylinder may be made from bar stock material or from an extruded tube. The act of increasing the inside diameter to a second dimension may be performed in single or multiple steps.

In another illustrative embodiment, the present invention is directed to a method of forming a heart valve stent that comprises providing a cylinder of material, the cylinder having an outside diameter and an inside diameter, the inside diameter having a first dimension, forming a plurality of stent posts on an end of the cylinder, performing a first operation to increase the inside diameter of the cylinder to an intermediate dimension, the intermediate dimension being greater than the first dimension, and performing a second operation to increase the inside diameter of the cylinder from the intermediate dimension to a second dimension, the second dimension being greater than the intermediate dimension.

In further embodiments, the method further comprises positioning the heart valve stent 22 in a fixture 30 comprised of a tube 31, a plurality of sets of spaced-apart holding pins 38 extending radially into the tube 31, each of the posts 20 of the stent 22 being positioned between a set of the holding pins 38, removably coupling an end cap 36 to the tube 31 to thereby secure the stent 22 within the tube 31, and holding the fixture 30 during the process of performing at least one of a honing operation and a boring operation on the inside diameter of the stent. In another embodiment, the stent 22 may be positioned in a fixture comprised of a tube 72 having a plurality of recesses 74 formed in the interior surface of the tube 72, the recesses 74 being configured to nest with the stent posts 20 formed on the cylinder of material to thereby prevent rotation of the stent during subsequent processing operations.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. The particular embodiments disclosed above may be altered or modified and all such variations are considered within the scope and spirit of the invention. Accordingly, the protection sought herein is as set forth in the claims below.

What is claimed is:

1. A method of forming a heart valve stent, comprising:
providing a cylinder of material, said cylinder having an outside diameter and an inside diameter, said inside diameter having a first dimension;
forming a plurality of stent posts on an end of said cylinder; and
increasing the inside diameter of said cylinder of material to a second dimension, said second dimension being greater than said first dimension.

2. The method of claim 1, further comprising cutting said cylinder of material to a desired length.

3. The method of claim 1, wherein said cylinder of material is comprised of a metal.

4. The method of claim 1, wherein said step of providing a cylinder of material comprises providing a cylinder of material comprised of at least one of an extruded tube of material and a machined section of bar stock material.

5. The method of claim 1, wherein said step of forming a plurality of stent posts comprises performing a milling operation to form a plurality of stent posts on an end of said cylinder.

6. The method of claim 1, wherein said step of increasing the inside diameter comprises increasing the inside diameter of said cylinder of material to a second dimension, said second dimension being greater than said first dimension, by performing at least one of an electrical discharge machining operation, a boring operation, a honing operation, a grinding operation, and a lapping operation.

7. The method of claim 1, wherein said step of providing a cylinder of material comprises:
performing a first operation to increase the inside diameter of said cylinder to an intermediate dimension, said intermediate dimension being greater than said first dimension but less than said second dimension;
and wherein said step of increasing the inside diameter to a second dimension comprises:
performing a second operation to increase the inside diameter of said cylinder from said intermediate dimension to said second dimension.

8. The method of claim 7, wherein said step of performing a first operation to increase the inside diameter of said cylinder to an intermediate dimension comprises performing at least one of an electrical discharge machining operation and a boring operation to increase the inside diameter of said cylinder to an intermediate dimension, said intermediate dimension being greater than said first dimension but less than said second dimension.

9. The method of claim 7, wherein performing a second operation to increase the inside diameter of said cylinder comprises performing at least one of a honing, grinding and lapping operation to increase the inside diameter of said cylinder from said intermediate dimension to said second dimension.

10. The method of claim 1, wherein said step of providing a cylinder of material comprises:
providing a section of bar stock material;
performing a machining operation to form said outside diameter; and
performing at least one of a drilling operation, a boring operation and an electrical discharge machining operation on said section of bar stock material to form said inside diameter to said first dimension.

11. The method of claim 1, wherein said step of providing a cylinder of material comprises:
providing a section of extruded tube;
performing a machining operation on said section of extruded tube to form said outside diameter; and
performing at least one of an electrical discharge machining operation, a drilling operation and a boring operation on said section of extruded tube to form said inside diameter to said first dimension.

12. The method of claim 1, further comprising:
positioning said cylinder of material in a fixture comprising a tube and a plurality of sets of spaced-apart holding pins extending radially into said tube, each of said stent posts being positioned between a set of said holding pins;
removably coupling an end cap to said tube to thereby secure said stent within said fixture; and
holding said fixture stationary during a process of performing at least one operation on said inside diameter of said cylinder.

13. The method of claim 1, further comprising:
positioning said cylinder of material in a fixture comprising a tube having a plurality of recesses formed in an interior surface of said tube, said recesses adapted to nest with said stent posts;
removably coupling an end cap to said tube to thereby secure said stent within said fixture; and
holding said fixture stationary during a process of performing at least one operation on said inside diameter of said cylinder.

14. A method of forming a heart valve stent, comprising:
providing a cylinder having an outside diameter and an inside diameter, said inside diameter having a first dimension;
performing a first operation to increase the inside diameter of said cylinder to an intermediate dimension, said intermediate dimension being greater than said first dimension;
forming a plurality of stent posts on an end of said cylinder; and
performing a second operation to increase the inside diameter of said cylinder from said intermediate dimension to a second dimension, said second dimension being greater than said intermediate dimension.

15. The method of claim 14, further comprising the step of cutting said cylinder of material to a desired length.

16. The method of claim 14, wherein said cylinder of material is metal.

17. The method of claim 14, wherein said step of providing a cylinder of material comprises providing a cylinder selected from the group consisting of an extruded tube of material and a machined section of bar stock material.

18. The method of claim 14, wherein forming a plurality of stent posts comprises performing a milling operation to form a plurality of stent posts on an end of said cylinder.

19. The method of claim 14, wherein said step of performing a first operation comprises performing at least one of an electrical discharge machining operation and a boring operation to increase the inside diameter of said cylinder to an intermediate dimension.

20. The method of claim 14, wherein said step of performing a second operation comprises performing at least one of a honing, grinding and lapping operation to increase the inside diameter of said cylinder from said intermediate dimension to a second dimension.

21. The method of claim 14, wherein said step of providing a cylinder of material comprises:
providing a section of bar stock material;
performing a machining operation to form said outside diameter; and
performing at least one of a boring operation and an electrical discharge machining operation on said section of bar stock material to form said inside diameter to said first dimension.

22. The method of claim 14, wherein said step of providing a cylinder of material comprises:
providing a section of extruded tube;
performing a machining operation on said section of extruded tube to form said outside diameter; and
performing at least one of an electrical discharge machining operation and a boring operation on said section of extruded tube to form said inside diameter to said first dimension.

23. The method of claim 14, further comprising the steps of:
positioning said cylinder of material in a fixture comprising a tube and a plurality of sets of spaced-apart holding pins extending radially into said tube, each of said stent posts being positioned between a set of said holding pins;
removably coupling an end cap to said tube to secure said stent within said tube; and
holding said fixture stationary during a process of performing at least one operation on said inside diameter of said cylinder.

24. The method of claim 14, further comprising the steps of:
positioning said cylinder of material in a fixture comprising a tube having a plurality of recesses formed in an interior surface thereof, said recesses adapted to nest with said stent posts;
removably coupling an end cap to said tube to secure said stent within said tube; and
holding said fixture stationary during a process of performing at least one operation on said inside diameter of said cylinder.

25. A method of forming a heart valve stent having a final inside diameter, comprising:
providing a cylinder of material, said cylinder of material having an initial inside diameter;
forming a plurality of stent posts on an end of said cylinder of material;
performing an electrical discharge machining operation to increase said inside diameter of said cylinder to an intermediate inside diameter, said intermediate inside diameter being greater than said initial inside diameter; and
performing at least one of a honing operation, a grinding operation and a lapping operation on said cylinder of material to increase said intermediate inside diameter to said final inside diameter of said stent, said final inside diameter being greater than said intermediate inside diameter.

26. The method of claim 25, further comprising the step of cutting said cylinder of material to a desired length.

27. The method of claim 25, wherein said cylinder of material is metal.

28. The method of claim 25, wherein said step of providing a cylinder of material comprises providing a cylinder of material comprised of at least one of an extruded tube of material and a machined section of bar stock material.

29. The method of claim 25, wherein said step of forming a plurality of stent posts comprises performing a milling operation to form a plurality of stent posts.

30. The method of claim 25, wherein said step of forming a plurality of stent posts comprises forming a plurality of stent posts on an end of said cylinder prior to increasing the inside diameter of said cylinder to said intermediate dimension.

31. The method of claim 25, wherein said step of providing a cylinder of material comprises:
providing a section of bar stock material;
performing a machining operation to form an outside diameter on said bar stock material; and
performing at least one of a drilling operation, a boring operation and an electrical discharge machining operation on said section of bar stock material to form said inside diameter to said initial inside diameter.

32. The method of claim 25, wherein said step of providing a cylinder of material comprises:
providing a section of extruded tube;
performing a machining operation on said section of extruded tube to form an outside diameter on said section of extruded tube; and
performing at least one of an electrical discharge machining operation and a boring operation on said section of extruded tube to form said initial inside diameter to said first dimension.

33. A method of forming a heart valve stent, comprising:
providing a cylinder of material, said cylinder having an outside diameter and an inside diameter, said inside diameter having a first dimension that is approximately 0.25-0.4 inches less than said outside diameter;
forming a plurality of stent posts on an end of said cylinder;
performing a first operation to increase the inside diameter of said cylinder to an intermediate dimension, said intermediate dimension being approximately 0.02-0.060 inches less than said outside diameter; and
performing a second operation to increase the inside diameter of said cylinder from said intermediate dimension to a second dimension, said second dimension being approximately 0.001-0.010 inches greater than said intermediate dimension.
